(19) United States
(12) Patent Application Publication
(10) Pub. No.: US 2024/0292787 A1
(43) Pub. Date: Sep. 5, 2024

(54) Tine Braces for Preventing Deflection of Wind-Guard Tines in a Baler or Other Ground-Traversing Collection Machine

(71) Applicant: Jordan J. Wiens, Steinbach (CA)

(72) Inventor: Jordan J. Wiens, Steinbach (CA)

(21) Appl. No.: 18/591,425

(22) Filed: Feb. 29, 2024

Related U.S. Application Data
(60) Provisional application No. 63/487,727, filed on Mar. 1, 2023.

(51) Int. Cl. A01D 89/00

(52) U.S. Cl. CPC A01D 89/008; A01D 89/001

(57) ABSTRACT

The invention concerns improvement of a ground-traversing collection machine of a type having a laterally spanning pickup reel, a wind-guard residing overhead of the pickup reel and featuring a laterally lying support and a plurality of hold-down tines projecting from the support bar in a longitudinally rearward direction of opposing the machine's travel direction to hold down the material as it is fed rearwardly from the pickup reel, and a set of stub augers positioned adjacent opposing ends of the pickup reel to convey the material laterally inward toward a midplane of the machine. In the inventive improvement, a set of one or more tine braces are installed on the wind-guard in positions reinforcing one or more of said hold-down tines against potential deflection thereof by the material during laterally inward conveyance thereof by the stub augers.

### CROSS-REFERENCE TO RELATED APPLICATIONS

This application claims benefit under 35 U.S.C. 119 (e) of U.S. Provisional Application No. 63/487,727, filed Mar. 1, 2023, the entirety of which is incorporated herein by reference.

### FIELD OF THE INVENTION

The present invention relates generally to ground traversing collection machines, such as agricultural round baler machines, that use a pickup reel to collect windrowed hay or other material from a ground surface traversed by the machine, and more particularly to the wind-guards of such machines that prevent blown material loss therefrom as the material is conveyed rearwardly from the pickup reel.

### BACKGROUND

In the agriculture industry, round balers have become quite prevalent for their capability of producing a conveniently sized cylindrical bale, very often automatically wrapped with a sheeting material such as net or film. The round balers generally have a baling chamber defined by a pair of spaced-apart side walls and a plurality of parallel belts entrained around a plurality of rollers spanning between the side walls. Such balers are ground-traversing machines that traverse across an agricultural field, for example in trailing relation to a towing vehicle (e.g. typically a tractor), to pick up windrowed hay from the ground using a rotating pickup reel that spans across a front inlet of the baling chamber. Typically, the pickup reel is accompanied by a wind-guard composed of a support bar lying generally parallel to the pickup reel in elevated relation thereto adjacent an upper front quadrant thereof, and a plurality of hold-down tines that, at spaced apart intervals along the support bar (and thus across the pickup reel) project rearwardly over the pickup reel, so that the material being picked up by, and rearwardly conveyed from, the pickup reel into the baling chamber is not blown out of this intended rearward conveyance path into the baling chamber.

Many balers also include a set of stub augers installed adjacent opposing ends of the pickup reel in slightly trailing and elevated relation thereof, such that driven rotation of these stub augers is operable to convey the material laterally inward toward a midplane of the machine from laterally outer regions of the baling chamber inlet as said material is fed rearwardly from the pickup reel into the baling chamber. A known problem with some balers of this type is that, at least in the instance of some particular types of hay or other collected material, this laterally inward augering of the material can cause at least some of the tines to be bent laterally inward toward the midplane of the machine, which can have detrimental effect on the machine's proper operation.

Accordingly, there exists a need for a product and or methodology to address this shortcoming of existing baler wind-guard designs. Though the invention is posited herein in the context of agricultural balers, it will be appreciated that the same teachings can likewise be applied to other variety of ground-traversing collection machinery that likewise employ pickup reels and accompanying wind-guards at the front inlet of the machine.

### SUMMARY OF THE INVENTION

According to a first aspect of the invention, there is provided a wind-guard improvement in a ground-traversing collection machine comprising a pickup reel that spans laterally transverse of a forward travel direction of said machine to pick up material from a ground surface traversed thereby, a wind-guard residing overhead of said pickup reel and composed of a support bar lying laterally transverse of said forward travel direction and a plurality of hold-down tines projecting from said support bar in a longitudinally rearward direction of opposing relation to said forward travel direction to hold down the material as it is fed rearwardly from the pickup reel, and one or more lateral augers positioned adjacent opposing ends of the pickup reel and operable to convey the material laterally inward toward a midplane of the machine from laterally outer regions thereof as said material is fed rearwardly from the pickup reel, said wind-guard improvement comprising a set of one or more tine braces installed or installable on the wind-guard in positions reinforcing one or more of said hold-down tines against potential deflection thereof by the material during laterally inward conveyance thereof by said one or more lateral augers.

According to a second aspect of the invention, there is provided a tine brace for installation on a ground-traversing collection machine of the aforementioned type, said tine brace comprising:
an elongated tine blocker running a longitudinal direction of the tine place for placement in adjacency to a respective one of the hold-down sides over at least a partial length thereof to block deflection of said respective one of the hold-down tines; and
one or more coupling elements of affixed relationship to said elongated tine block, and arranged for removably coupled attachment to the support bar to hold said elongated tine blocker in said adjacency to said respective one of the hold-down tines.

According to a third aspect of the invention, there is provided a method of adapting a ground-traversing collection machine for use in collecting a particular type of material using a pickup reel of said ground-traversing collection machine that is accompanied by a wind-guard having a plurality of hold down-tines, said method comprising selectively installing or removing a set of one or more tine braces on at least a subset of said hold-down tines according to whether said particular type of material is, or is not, one whose proper collection and handling by the machine would be negatively impacted by presence of said one or more tine braces on said hold-down tines of the wind-guard, to a degree exceeding beneficial reinforcement of the hold-down tines against deflective loading.

### BRIEF DESCRIPTION OF THE DRAWINGS

Preferred embodiments of the invention will now be described in conjunction with the accompanying drawings in which:

FIG. 1 is a front perspective view of a prior art pickup assembly of a round baler used in the agriculture industry to collect and bale windrowed hay from a field.

FIG. 2 is another front perspective view of the pickup assembly of FIG. 1, with schematic illustration of material flow therethrough during use of the machine.

FIG. 3 is another front perspective view of the pickup assembly with schematic material flow, similar to FIG. 2, but illustrating how such material flow can cause lateral bending of hold-down tines on a wind-guard of the pickup assembly.

FIG. 4 is a schematic front perspective view illustrating combination of the pickup assembly of the preceding figures with a set of rollers that trail the pickup assembly in a baling chamber of the baler to form round bales of the pickup-collected material.

FIG. 5 is a schematic side perspective view of the overall baler.

FIG. 6 is a top plan view of a wind-guard from a prior art pickup assembly, on which there is shown installed a tine brace of a first embodiment of the present invention, for the purpose of resisting bending of a respective hold-down tine of the wind-guard during use of the baler.

FIGS. 7A, 7B and 7C are top, end and side views, respectively, of the first embodiment tine brace of FIG. 6.

FIGS. 8A, 8B and 8C are top, end and side views, respectively, of a second embodiment of the tine brace.

FIGS. 9A, 9B and 9C are top, end and side views, respectively, of a third embodiment of the tine brace.

FIGS. 10A, 10B and 10C are top, end and side views, respectively, of a fourth embodiment of the tine brace.

FIGS. 10D and 1E are exploded side perspective and assembled side elevational views, respectively, of the fourth embodiment tine brace and a cooperating snap-clamp used to fasten the tine brace to a support bar of the wind-guard.

FIGS. 11A, 11B and 11C are top, end and side views, respectively, of a fifth embodiment of the tine brace.

FIGS. 12A, 12B and 12C are top, end and side views, respectively, of a sixth embodiment of the tine brace.

FIGS. 13A, 13B and 13C are top, end and side views, respectively, of a seventh embodiment of the tine brace.

FIGS. 14A, 14B and 14C are top, end and side views, respectively, of an eighth embodiment of the tine brace.

FIGS. 15A, 15B and 15C are top, end and side views, respectively, of a ninth embodiment of the tine brace.

FIGS. 16A, 16B and 16C are top, end and side views, respectively, of a tenth embodiment of the tine brace.

FIGS. 17A, 17B and 17C are top, end and side views, respectively, of an eleventh embodiment of the tine brace.

### DETAILED DESCRIPTION

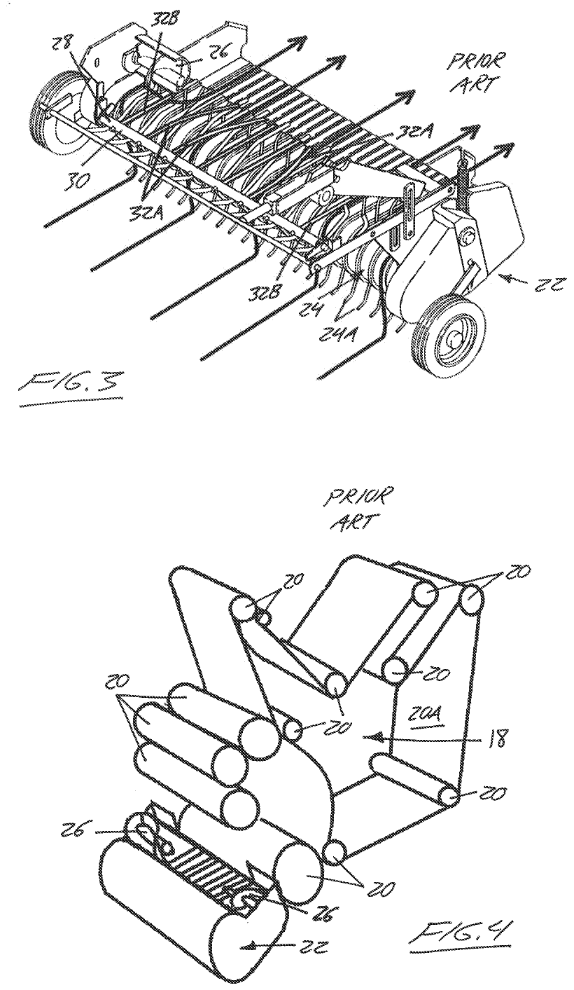

FIG. 5 schematically shows a conventional round baler 10 in side elevational profile, the general construction and componentry of which will be familiar to those of ordinary skill in the art of the agricultural machinery. The round baler 10 features a pull tongue 12 at a leading front end of the machine for connection to a tow vehicle, typically a tractor, for towed ground conveyance of the round baler 10 over an agricultural field in a forward travel direction F. The pull tongue 12 denotes a frontmost section of a wheeled frame of the baler 10, which can travel over the field by way of a pair of ground wheels, one of which is shown at 14, that are respectively installed at opposite ends of a transverse axle so as to reside at opposing outer sides of the frame. Atop a rear section of the wheeled frame is mounted a housing 16 of the baler 10, opposing side walls of which delimit an internal baling chamber 18, inside of which there are contained a plurality of cooperating rollers 20 that span between the side walls, and about a subset of which a set of belts, shown schematically at 20A, are entrained to perform baling of collected hay fed into the baling chamber 18 through a front inlet thereof during towed use of the baler 10.

To pick up the windrowed hay from the field and feed same into the baling chamber 18 through the front inlet thereof, which is found at a lower front quadrant of the housing 16, a pickup assembly 22 spans laterally across this front inlet in perpendicularly transverse relationship to the forward travel direction F, thus lying in parallel relation to the rollers 20 that span laterally across the interior of the baling chamber 18, and likewise parallel to the transverse axle shared by the ground wheels 14. The pickup assembly 22 features a rotationally driven pickup reel 24 spanning laterally across the front inlet of the baling chamber 18 in parallel relation to the rollers 20. The pickup reel 24 is rotationally driven in a predetermined direction (clockwise in FIG. 5) so that tines 24A projecting radially outwardly of the reel's rotational axis pick up the windrowed hay from the field, carry it upwardly over-center of the reel, and throw it rearwardly through the front inlet of the baling chamber 18. The illustrated pickup assembly 22 also includes a pair of stub augers 26 sharing a common rotational axis of parallel relation to that of the pickup reel 24 in upwardly and rearwardly offset relation to the pickup reel 24, and each residing adjacent a respective end of the pickup reel and spanning only a fractional of the pickup reel's length at a laterally outermost region thereof. Each stub auger 26 is rotationally driven in a direction acting to force the hay coming rearwardly off of the pickup reel 24 laterally inward to a longitudinal midplane of the baler. This way, the length of the pickup reel 24, and the effective working width thereof over which material is collectible from the field, can somewhat exceed the actual width of the front inlet of the baling chamber 18. The functional result is that the swath of hay is laterally compacted as it is fed into the baling chamber 18.

As an alternative, instead of a pair of separate stub augers, each having its own dedicated auger shaft, some machines instead employ a singular full-length auger whose shaft spans an entire length of the pickup reel 24, and is equipped with oppositely pitched auger flighting at opposing end regions of this auger's singular shaft. The present invention can be implemented in any variety of machine, regardless of its particular quantity and setup of auger(s) used for the laterally inwardly conveyance of the picked-up material. Accordingly, reference herein to one or more lateral augers is meant to encompass at these explicitly described auger setups, as well as any other functionally comparable or equivalent alternatives.

In addition to the pickup reel 24 and the stub augers 26, the pickup assembly 22 also feature a wind-guard 28 composed of a support bar 30 lying generally parallel to the pickup reel 24 in elevated relation thereto adjacent an upper front quadrant thereof, and a plurality of hold-down tines 32A, 32B that, at spaced apart intervals along the support bar 30, and thus at laterally spaced intervals across the pickup reel 24, project rearwardly over the pickup reel 24. These hold-down tines 32A, 32B, referred to as such to distinguish over the pickup tines 24A of the pickup reel, serve to hold down the material being moved rearwardly over-center of the pickup reel 24 and into the baling chamber 18, so that such material is not blown out of this intended rearward conveyance path through the baling chamber's front inlet. A center subset of the hold-down tines (center tines, for short) 32A are longer than two outer subsets of the hold-down tines (outer tines, for short) 32B that reside on either side of the center tines 32A. The outer tines 32B reside at laterally outer regions of the support bar 30, behind which the stub augers 26 of the pickup assembly 22 reside, hence the shorter length of these outer tines 32B so as to stop short of operative intrusion into the operating areas the stub augers.

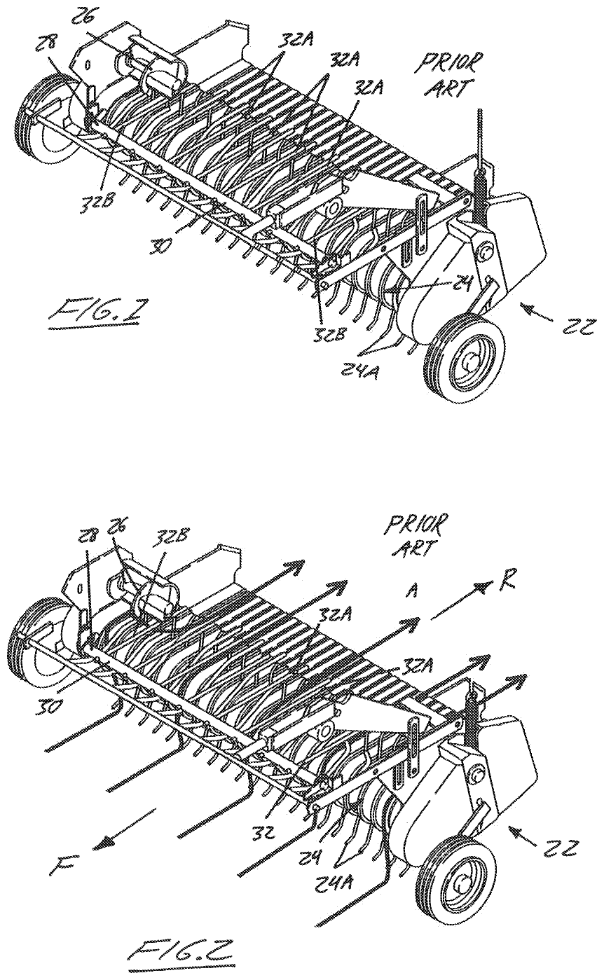

So far, this description of the baler 10 and its pickup assembly 22 denote a conventional design shared among several known balers of the prior art. FIGS. 1 through 3 show one such example of a prior art pickup assembly 22 in a less schematic and more detailed form, in which additional frame, housing, ground wheel, and wind-guard support componentry are shown, though such features may vary in a variety of ways, while still denoting a viable operating environment in which the present invention may be useful. FIG. 2, schematically illustrates flow of collected hay from the field as the pickup assembly 22 travels over the field in the forward travel direction F. At the bottom front quadrant of the pickup reel 24, the windrowed hay is lifted from the field, and swept rearwardly over-center of the pickup reel 24 beneath the hold-down tines 32 of the wind-guard 28, and then rearwardly through the front inlet of the baling chamber 18 in a rearward direction R of parallel but opposing relation to the forward travel direction F of the baler 10. The term longitudinal is used herein to refer to the parallel and horizontal directionality shared by these forward and rearward directions F, R, in contrast to the term lateral that is used to refer to a horizontal directionality of perpendicularly transverse relationship to the longitudinal direction. A longitudinal midplane of the baler thus refers to a vertical plane that lies longitudinally of the machine, and is perpendicularly intersected by the pickup reel 24, the wind-guard support bar 30, and the rollers 20 of the baling chamber 18.

As shown by the bolded arrows of FIG. 2 that schematically denote the conveyance path of the hay during its collection by the baler 10, the stub augers 26 behind the pickup reel 24 impart a laterally inward redirection of the hay that is picked up at the outermost regions of the pickup reel 24, forcing it inwardly toward the midplane of the baler 10. FIG. 3 illustrates a problematic result that is known to sometimes occur with use of such balers 10, for example depending on the particular type or conditions of the hay being collected from the field, where the auger-forced inward movement of the hay bends one or more of the hold-down tines 32A, 32B laterally inward toward the midplane of the baler 30, thus denoting damage to the machine that can be detrimental to the proper operation thereof. The longer center tines 32A reside at a central region of the support bar 30 between the two stub augers 26, and it is these longer center tines 32A that are particularly prone to the aforementioned bending problem. On the other hand, shorter tines that don't fully reach or pass the auger(s) can also experience problematic bending in some machines, as a bulk amount of material conveyed by the auger can drag across the tips of such shorter hold-down tines, and cause lateral bending thereof.

It is in the interest of preventing this problematic bending of the hold-down tines 32A, 32B of the wind-guard 28 that the present invention was particularly developed, and though described in the context of an agricultural baling machine where the problem was recognized by the inventor, it will be appreciated from the following description that the novel and inventive solution described herein can be similarly employed in any variety of ground-traversing, material-collecting machines (e.g. forage harvesters) that likewise features a pickup reel and associated wind-guard.

FIG. 6 illustrates a wind-guard 28, which is again an example of a wind-guard having a variable tine length, where a center subset of the hold-down tines (center tines, for short) 32A are longer than two outer subsets of the hold-down tines (outer tines, for short) 32B that reside on either side of the center tines 32A. Once again, the outer tines 32B reside at laterally outer regions of the support bar 30, behind which the stub augers 26 of the pickup assembly 22 reside, hence the shorter length of these outer tines 32B so as to stop short of operative intrusion into the operating areas the stub augers. The longer center tines 32A reside at a central region of the support bar 30 between the two stub augers 26, and it is these longer center tines 32A that are particularly prone to the aforementioned bending problem. The hold-down tines 32A, 32B all project rearwardly from the support bar 30 at a rear side thereof. In the illustrated example, the support bar 30 features a predefined set of holes 34 penetrating therethrough from the front side thereof to the opposing rear side from which the hold-down tines 32A, 32B project, at locations each situated (e.g. midway) between an adjacent pair of the hold-down tines, as is the case of some commercially available wind-guards and balers. As will be described, some embodiments of the present invention exploit such predefined holes 34 in the support bar, and in other instances where the support bar lacks predefined holes therein, such holes may be drilled in the support bar by an installer of such embodiments. Other embodiments employ alternative means of attachment to the wind-guard that requires no such holes in the support bar 30 thereof.

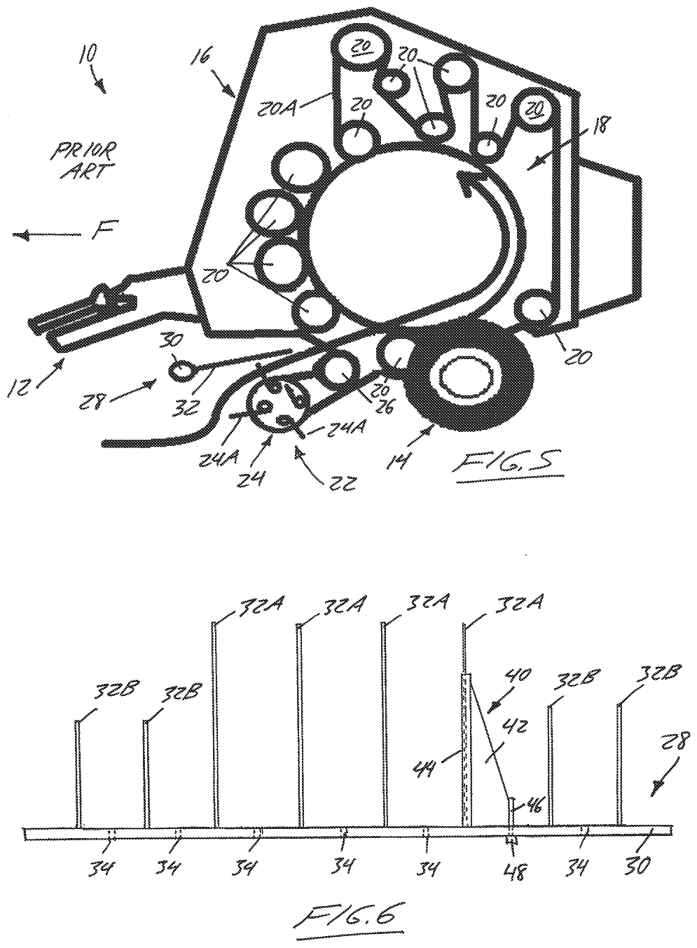

FIGS. 6 and 7 show a first embodiment of a novel tine brace 40 of the present invention, which is composed of a flat plate 42, for example made of steel, other metal or other relatively rigid material (e.g. rigid plastic or composite), a tine blocker 44 affixed to the plate 42 in a position spanning along a longitudinal edge 42A edge thereof, and a coupling element 46 affixed to the plate at a position residing across the plate from the tine blocker 44 at a front end of the tine brace 40. At this front end of the tine brace 40, a lateral front edge 42B of the plate 42 spans from the coupling element 46 to the tine blocker 44 in an orientation of perpendicularly transverse relation to the longitudinal edge 42A. In this embodiment, the plate 42 is characterized by an oblique edge 42C spanning forwardly from a rear terminus of the tine blocker 44 at a rear end of the tine brace 40, and at an angle of acutely oblique relation to the longitudinal edge 42A. The oblique edge 42C spans most of a longitudinal distance from the rear end of the tine brace 40 to the front end thereof, but stops somewhat short of the front end, without intersecting the lateral front edge 42B. A short connecting edge 42D instead joins the oblique edge 42C to the lateral front edge 42B, and is parallel to the opposing full-length longitudinal edge 42A. Connecting edge 42D may therefore also be referred to as a longitudinal edge due to its parallel relationship to full-length longitudinal edge 42A, but may be distinguished therefrom by characterization thereof as a shorter longitudinal edge 42D.

In this first embodiment, the tine blocker 44 is a tubular cylinder, for example formed of a length of steel pipe, which in the case of steel plate 42, may be welded thereto, though the material composition of the tine blocker 44 may employ other materials, including those contemplated above for the plate, in which case the particular mode of attachment between the plate 42 and tine blocker 44 may also likewise vary, including instances of integral attachment, e.g. by casted or molded production of the tine blocker 44 and plate 42 as a singular piece. In the first embodiment, the coupling element 46 is a threaded coupling stud, again of any variety of suitably rigid material, affixed, again by any variety of welded, integral or otherwise secured attachment, to the shorter longitudinal edge 42D of the plate in a position spanning forwardly beyond the lateral front edge 42B of the plate. At least a distal portion of the coupling stud's projecting length from the front end of the plate is externally threaded, starting from a terminal front end thereof furthest from the plate 42. The inner diameter of the tubular tine-blocker 44 slightly exceeds the outer diameter of the wind-guard tines 32A, 32B, or at least the bending-prone center tines 32A thereof should the center and outer tines 32A, 32B not share the same diameter. The outer diameter of the coupling stud 46 is slightly lesser than the diameter of the holes 34 in the wind-guard support bar 30.

Though FIG. 6 only illustrates installation of one tine brace 40 on one of the bending prone tines 32A, in practice, one such tine brace 40 will be installed on each bending prone tine 32A of the wind-guard 28. In the first embodiment, such installation is performed by sliding of the tubular tine blocker 44 onto the respective tine 32A at a distal rear end thereof furthest from the support bar 30, and sliding the tine brace 40 onward into adjacency with the rear side of the support bar 30, during which the projecting part of the coupling stud 46 is inserted through the hole 34 in the support bar 30, until the lateral front edge 42B of the plate 42 abuts the rear side of the support bar 30. An internally threaded fastening nut 48 is then threaded onto the coupling stud 46 at the front side of the support bar 30 to fasten the tine brace 40 in place, with the front end of the tubular tine blocker 44 and the lateral front edge 42B of the plate 42 both abutted firmly and securely against the rear side of the support bar 30, thus completing the installation of the tine brace 40. In this installed position of the tine brace 40, the tubular tine blocker 44 circumferentially surrounds the tine over at least a majority of its length, but in unaffixed relation thereto, while the coupling stud 46 and cooperating nut 48 provide fastened connection of the plate 42 and attached tine blocker 44 to the support bar 30, whereby attempted lateral deflection of the braced tine 32A inwardly toward the midplane of the baler by auger-displaced hay is blocked by the tine-surrounding tine blocker 44, which in turn is held steady by its fastener anchored attachment to the support bar 30.

In the illustrated example, the hole 34 penetrated by the coupling stud 46 is the hole 34 on the outer side of the respective tine 32A, i.e. the side thereof closer to the nearest end of the support bar 30 (and thus closest to the nearest outer tine 32B, in the illustrated case where the respective tine is a center tine 32A). This way, because the fastened connection of the tine brace 40 is on the outer side of the tine, the force exerted on the plate 42 during attempted inward deflection of the tine 32A by the inwardly augered hay is a tensile force attempting to pull the tine blocker 44 away from the fastened coupling stud 46, not a compressive force attempting to push the tine blocker 44 toward the fastened coupling stud 46, as orientation of the tine brace in such a compressive loading context may reduce its load bearing capacity. That being said, the tine brace 40 may be installed in the reverse orientation fastened to the hole on the inner side of the tine, if the tine brace 40 has sufficient design strength for the anticipated loads. The connecting body between the tine blocker 44 and the coupling stud 46 need not necessarily be a flat, relatively thin plate, for example whose thickness is less than one or both of the tube blocker's inner diameter and the coupling stud's outer diameter, as shown in FIGS. 7B and 7C. That said, the use of a flat plate, which in the installed position resides in coplanar relationship with the tines 32A, 32B in a position between an adjacent pair thereof, is speculated to be less disruptive to material flow through the pickup assembly during use than if a bulkier connection body was used in place of such plate 42.

In this embodiment, the oblique edge 42C of the plate imparts the plate with a tapered width, measured between the oblique edge 42C and the full-length longitudinal edge 42A. This tapered width grows wider in a forward direction moving toward the front end of the tine brace 40, and thus likewise grows wider toward the support bar 30 of the wind-guard 28 in the installed position of the tine brace 40. This tapered width, growing narrower in the opposing rearward direction away from the support bar 30 reduces the amount of plate-occupied area between the adjacent tines of the wind-guard, and is therefore speculated to be of lesser potential disruption to the normal material flow that would occur during conventional use of the wind-guard without any tine braces, in which instances the space between each pair of adjacent tines is entirely open. While the total plate-occupied area, and the weight of the plate 42, could be further reduced by inclusion of one or more holes therein, a solid continuous plate surface is believed to be of less disruptive effect to material flow, compared to plates with one or more holes or perforations, on which material may snag, and cause disruption to the material flow.

FIG. 8 shows a second embodiment of the tine brace 140, which again features a plate 142 with a tine blocker 144A running along a full-length longitudinal edge 142A of the plate 142, and a coupling stud 146 that projects longitudinally from the front end of the plate 142, but in this case, the tine blocker 144A on one side of the plate 142 is accompanied by a matching second tine blocker 144B that resides across the plate 142 from the first tine blocker 144A. This second tine blocker 144B spans a second full-length longitudinal edge 142C of the plate 142, which has a rectangular shape of uniform width in this embodiment, rather than the tapered width possessed by the more triangular plate of the preceding embodiment. In this embodiment, the two tine blockers 144A, 144B are respectively slid onto two adjacent tines 32A during installation of the tine brace 140, and the coupling stud 146 projects from a mid-point of the lateral front edge 142B of the plate 142 so as to align with, and penetrate through, the respective hole 34 in the support bar 30 mid-way between those two adjacent tines. A threaded fastening nut 48 is again used to anchor the tine brace 140 in place. In this embodiment, a singular tine brace 140 is thus operable to prevent deflection of two neighbouring tines of the wind-guard 28. The space between that pair of neighbouring tines is more greatly occupied by the larger rectangular plate 142 in this embodiment, compared to the tapered plate of the preceding embodiment. On the other hand, the space between every second pair of adjacent braced tines can be left entirely unoccupied in use of the second embodiment.

In an unillustrated variant of the second embodiment, an additional plate with its own respective coupling stud 146 and another tine blocker can be added to either side of the illustrated example, whereby the tine blocker would be installable on a set of three adjacent tines. Such extension of the tine brace may extend to addition of yet another one or more additional plates each adding another tine blocker, whereby a single device may span any quantity of adjacent tines, for example the full set of center tines 32A, and possibly further spanning some or all of the outer tines 32B.

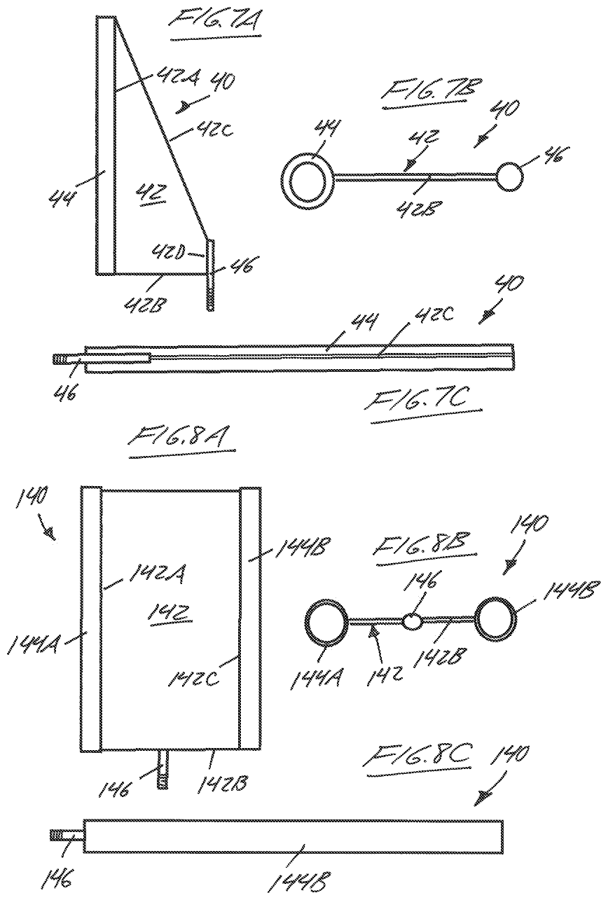

FIG. 9 shows a third embodiment of the tine brace 240, which like the first embodiment features a plate 242 of tapered width having a tine blocker 244 running along a full-length longitudinal edge 242A of the plate 242, and a coupling stud 246A that projects longitudinally from the front end of the plate 142 at a distal end of the lateral front edge 242B furthest from the tine blocker 244, but in this case, the plate 242 on one side of the tine blocker 144 is accompanied by a matching second plate 243 situated in coplanar relationship with the first plate 242 on an opposing second side of the tine blocker 144. The tine blocker 144 disposed between the two plates 242, 243 thus spans along the respective full-length longitudinal edge 242A, 243A of each plate 242, 243. Like the first plate 242, the second plate 243 likewise has its own respectively coupling stud 246B that projects longitudinally from the front end of the plate 243 at the distal end of the plate's lateral front edge 243B. During installation of this embodiment, the singular tine blocker 144 is slid onto a singular respective tine 32A of the wind-guard 28, just like in the first embodiment, and the two coupling studs 246A, 246B are inserted into penetrating relationship to an adjacent pair of the holes 34 in the support bar on opposing sides of the singular respective tine 32A. Respective fastenings nuts 48 are threaded onto the two coupling studs 246A, 246B to anchor the tine brace 240 in place.

This dual plated embodiment of the tine brace 40 thus braces the respective tine 32A on both sides thereof for improved resistance to bend-imparting deflection forces exerted on the tine 32A during use of the baler. In the illustrated example, the two plates are of triangular shape with respective oblique edges 242C, 243C, which in this instance directly intersect the lateral front edges 242B, 243B of the plates at pointed outer corners of the plates, where the respective coupling studs 246A, 246B reside. Alternatively, the oblique edges 242C, 243C may be truncated into non-intersecting relationship with the lateral front edges 242B, 243B, in favour of a shorter longitudinal edge that connects the two, like in the first embodiment.

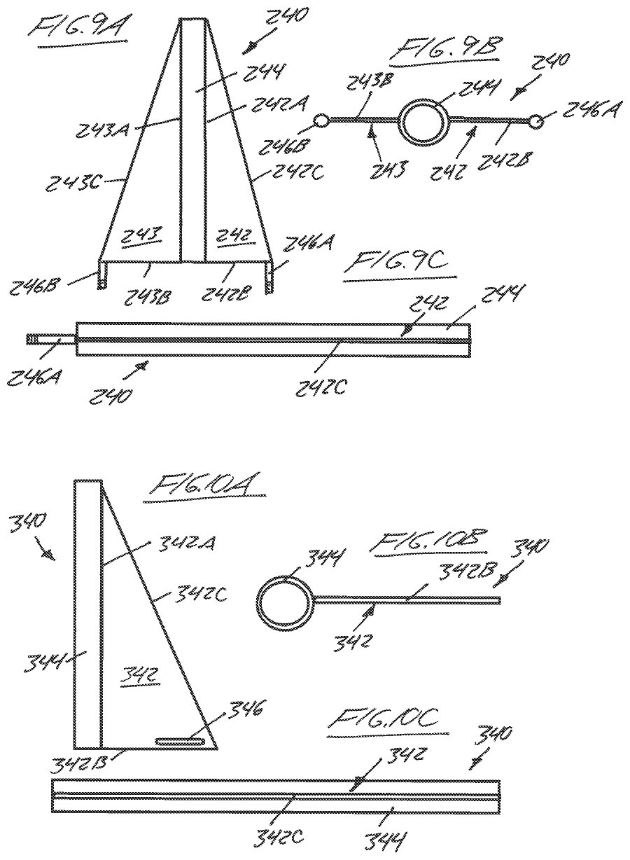

FIG. 10 shows a fourth embodiment of the tine brace 340, which like the first embodiment features a plate 342 having a tine blocker 344 running along a full-length longitudinal edge 342A of the plate 342, and an oblique edge 342C imparting a tapered width to the plate 342 between this oblique edge 342C and the full-length longitudinal edge 342A. The oblique edge 342C and lateral front edge 342B may intersect at a point (as shown), like in the third embodiment, or may instead be interconnected by a shorter longitudinal edge, like in the first embodiment. Instead of a coupling stud attached to the plate, like in the preceding embodiments, the coupling element on the tine brace 340 of this embodiment is a coupling slot 346 defined in the plate 342 near the lateral front edge 342B thereof.

With reference to FIGS. 10D and 10E, instead of using a threaded fastening nut 48 as the accompanying fastener to anchor the tine brace 340 in place on the support bar 30, this embodiment instead employs a resilient snap-clamp 348 having a C-shaped channel profile 348A whose arcuate span is greater than 180-degrees, but less than 360-degrees so as to leave an open side of the channel profile, at which the two elongated edges of the channel have respective flanges 348B, 348C. Flange 348B is Z-shaped in profile to enable hooked engagement thereof in the coupling slot 346 of the tine brace 340 when the snap-clamp is forced onto the support bar 30 of the wind-guard 28 into snap-fit relation therearound, as shown in FIG. 10E. So, as with the preceding embodiments, installation of the tine brace 340 starts with sliding of the tubular tine blocker 344 onto a respective tine 32A of the wind-guard, along which the tine brace 340 is slid until the plate's lateral front edge 342B reaches close or abutting adjacency to the support bar 30, whereupon instead of threading a fastening nut 50 onto a threaded coupling stud penetrating through a hole 34 in the support bar, the snap-clamp 348 is snapped onto the support bar 30 in a position engaging its hooking flange 348B with the coupling slot 346 in the plate 342 of the tine brace 340, thereby fastening the tine brace 340 to the support bar 30.

FIG. 11 shows a fifth embodiment of the tine brace 440, which features a plate 442 and tubular tine blocker 444 of identical configuration to those of the fourth embodiment, and that again uses an opening in the plate 342 to effect clamped coupling of the tine brace 440 to the support bar 30 of the wind-guard 28, with the only difference being the shape of this opening. Instead of the elongated coupling slot 346 of the fourth embodiment to accommodate a hooking flange 348B of a snap-clamp 348, the coupling element in this embodiment is simply a round coupling hole 446 to accommodate a screw or bolt of a non-snapping mechanical clamp (not shown) that requires engagement such a screw or bolt fastener through fastening flanges of the clamp to secure the clamp closed around the support bar 30 of the wind-guard.

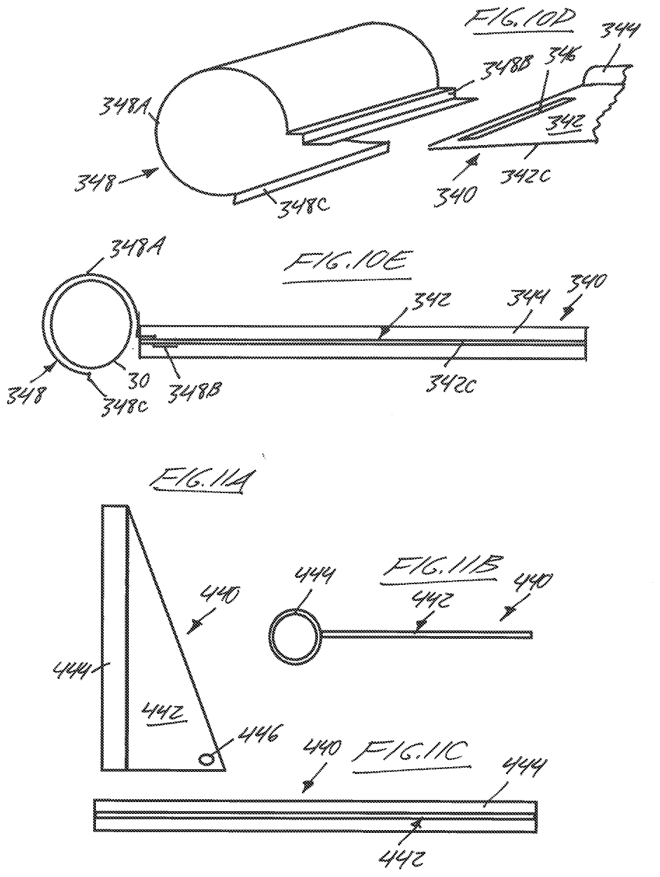

FIG. 12 shows a sixth embodiment of the tine brace 540, which features a plate 542 and tubular tine blocker 544 of identical configuration to those of the first embodiment, but in place of the first embodiment's threaded coupling stud 46, features a protrusive pin coupling 546 that likewise projects forwardly from the front end of the plate 542 at the distal end of the lateral front edge 542B thereof. Near a distal end of this pin coupling 546, a through-bore 546A penetrates therethrough to enable insertion of a lynch pin (or other locking pin) through the pin coupling 546 at the front side of the wind guard support bar 30 for the purpose of anchoring the tine brace 540 in place in its installed position. Such locking pin replaces the threaded nut(s) 34 used in the preceding embodiments. This pin coupler 546 may be a cylindrically round stud like the threaded studs of the preceding embodiments, but may alternatively be any shape capable of penetrating through a respective one of the holes 34 in the wind-guard support bar 30. For example, as illustrated, the pin coupler may be a relatively flat piece of metal stock welded to the plate 542, or may be an integral extension of the plate itself, for example as part of a cast or molded piece.

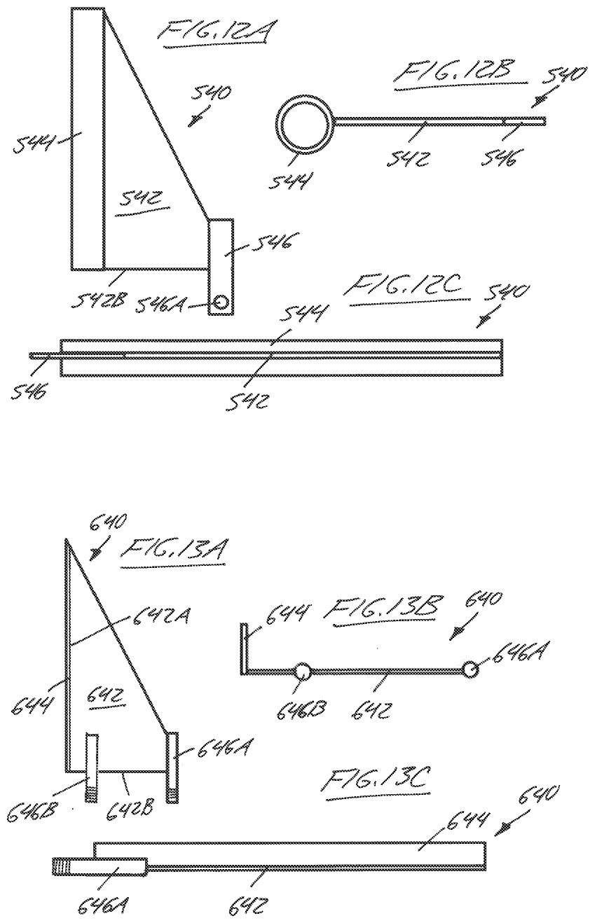

FIG. 13 shows a seventh embodiment of the tine brace 640, which features a plate 642 and threaded coupling stud 646A of identical configuration to those of the first embodiment, of which the threaded coupling stud 646A may alternatively be replaced with the pin coupler 546 of the preceding embodiment. In this embodiment, instead of having a tubular form like the tine blockers of the preceding embodiments, the tine blocker 644 is an elongated straight flange that is affixed to, and projects perpendicularly from the plane of, the plate 642 at the longitudinal edge 642A thereof. This straight-flange tine blocker 644 may be a piece of metal stock welded to the plate 642, or may be an integral extension of the plate 642, e.g. a bent marginal strip of a metal plate, or an integrally cast or molded flange of a cast or molded piece. So whereas the tubular tine blockers of the preceding embodiments reside in closely adjacent and circumferentially surrounding relation to the respective tines on which they are installed, the straight-flange tine blocker 644 resides laterally and closely adjacent to the respective tine 32A, but in non-surrounding relation thereto, yet is still suitably positioned to block lateral deflection thereof. While the illustrated example of the tine brace 640 has an L-shaped profile in end view (FIG. 13B), with the straight-flange tine blocker 644 projecting to only one side of the plate 642, it may have a T-shaped profile in other variations of this embodiment, with the straight-flange tine blocker 644 projecting to both sides of the plate 642.

To hold the installed tine brace 640 in a static position, so as not to rotate about the axis of the coupling stud 646A, a second coupling stud 646B (or an equivalent pin coupler 546) is affixed to the plate 642 and likewise projects forwardly from the lateral front edge 642B thereof, thus requiring an additional hole in the support bar 30 through which the second coupling stud 646B is penetrable for fastened connection to the support bar using a second threaded nut 50. In this embodiment, the tine brace 640 may be installed with its plate on the inner side of the respective tine, not the outer side thereof, so that the blocking flange 644 runs along the inner side of the respective tine to block inward deflection thereof. Alternatively, with the coupling studs 646A, 646B fastened to the support bar 30 at the outer side of the respective tine 32A, the plate 642 may span over or under the respective tine 32a to place the blocking flange 644 at the opposing inner side of the respective tine 32A. In such instances where the plate 642 spans overtop of the respective tine 32A, it may be possible to omit the second coupling stud 646B if the weight of the tine brace, whose plate rests atop the tine, is sufficient to keep the tine brace from rotating out of its working position without a second fastening point to the support bar 30.

FIG. 14 illustrates an eighth embodiment of the tine brace 740, which features a plate 742 and threaded coupling stud 746 of identical configuration to those of the first embodiment, of which the threaded coupling stud 746 may again be replaced with the pin coupler 546 of the sixth embodiment. In the present embodiment, the tine blocker, instead of the straight-flange tine blocker 644 of the seventh embodiment, is a hook-flange tine blocker 744 of curved U-shaped profile that runs longitudinally of the plate 742 at the longitudinal edge 742A thereof to embrace partially around the respective tine 32A at the inner side thereof, while the threaded coupling stud 746 is received in a hole 34 of the support bar 30 and fastened with a threaded nut 48 at the opposing outer side of the respective tine 32A. The installation is the same as for the first embodiment, except that the hook-flange tine blocker 744 spans only partially around the circumference of the respective tine 32A of the wind-guard 28, instead of fully therearound like the tubular tine blockers of earlier embodiments.

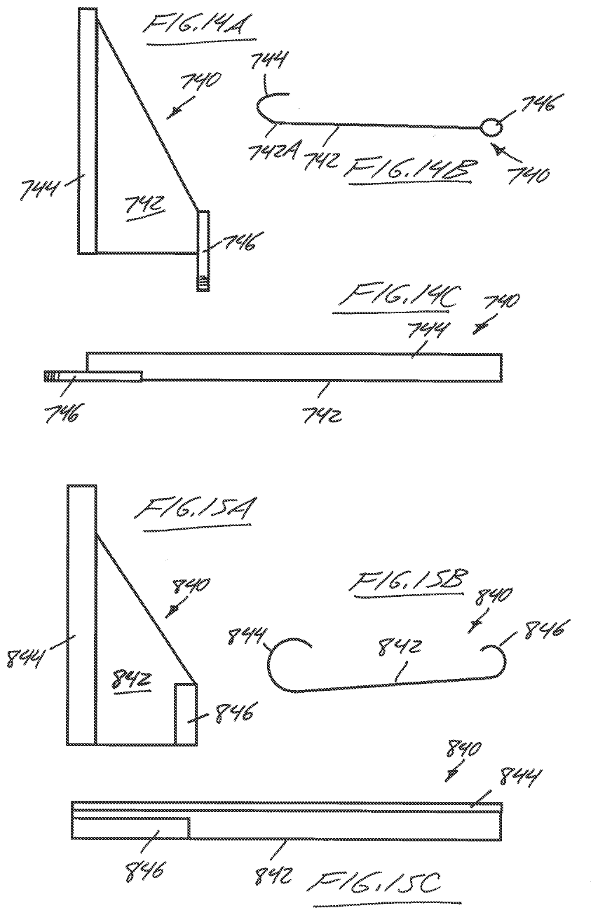

FIG. 15 illustrates a ninth embodiment of the tine brace 840, which features a plate 842 and a hook-flange tine blocker 844 of identical configuration to those of the eighth embodiment, but in place of the threaded coupling stud or pin coupler, features a bolting flange 846 of also curved U-shaped profile and longitudinal orientation residing across the plate 842 from the hook-flange tine blocker 744. The bolting flange 846 is situated in laterally reversed orientation to the hook-flange tine blocker 844, so that the open sides of the two U-shaped flanges 844, 846 face toward one another. The bolting flange 846 replaces the plate-affixed coupling stud or pin coupler of the preceding embodiments, but likewise resides in alignable relation to one of the holes 34 in the wind-guard support bar 30, thereby enabling similar bolted connection of the tine brace 40 thereto, but using a separate unaffixed fastening bolt rather than an affixed coupling stud. To install this embodiment, the hook-flange tine blocker 844 is slid onto and along the respective tine 32A until the lateral front edge of the plate 842 reaches the rear side of the wind-guard support bar 30, just as in the preceding embodiments. With the U-shaped profile of the bolting flange 846 aligning the open interior of it's U-shape with the nearby hole 34 in the support bar 30, a bolt is fed through the hole 34, and through the open interior of the bolting flange's U-shape, and then mated with a compatibly threaded nut 48. In the installed position of this tine brace 840, the hook-flange tine blocker 844 partially embraces the respective tine 32A at the inner side thereof to block inward deflection of said respective tine 32A, while the bolting flange 846 hooks around the shaft of the bolt. Instead of a U-shaped flange open at the side thereof facing the tine blocker 844, the integral bolting flange 846 be replaced with a closed eye that curves a full 360-degrees back to the plate, and thus spans fully around the bolt in the installed position.

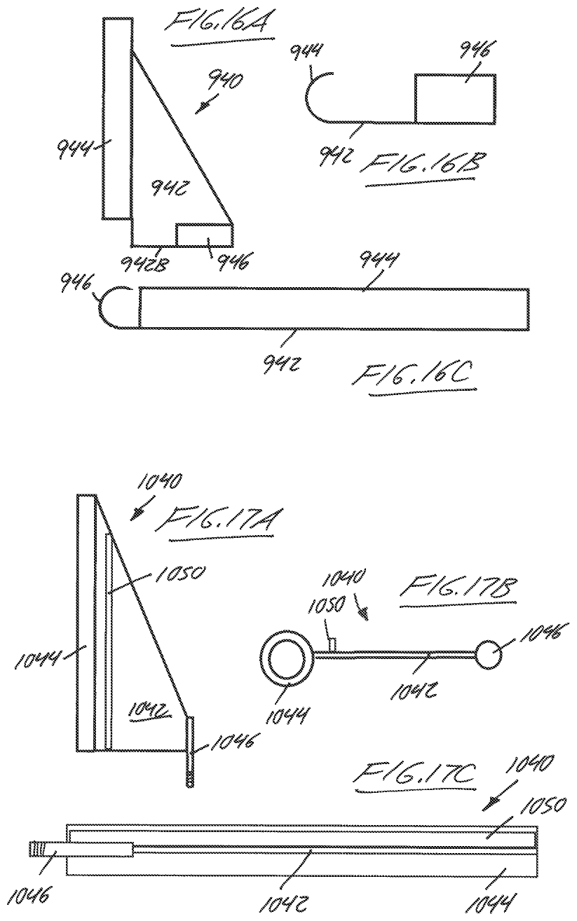

FIG. 16 illustrates a tenth embodiment of the tine brace 940, which features a plate 942 and U-shaped hooking flange 944 like those of the eighth and ninth embodiments, but in place of the threaded coupling stud of the eighth embodiment or longitudinally oriented bolting flange 846 of the ninth embodiment, features a laterally oriented hook-flange 946 of U-shaped profile spanning laterally of the plate over an outer region of the plate's lateral front edge 942B. In this installed position of this tine brace 940, the hook-flange tine blocker 944 partially embraces the respective tine 32A at the inner side thereof to block inward deflection of the respective tine 32A, while the laterally oriented hook-flange 846 partially embraces the wind-guard support bar 30 at the front side thereof, thereby omitting the need for a threaded nut 48, snap-clamp 348 or other separate fastener to anchor the tine-brace 940 in place on the wind-guard 28.

Finally, FIG. 17 illustrates an eleventh embodiment of the tine brace 1040, which includes a plate 1042, tubular tine blocker 1044, and threaded coupling stud 1046 of identical configuration to those of the first embodiment, and of which the threaded coupling stud 1046 may once again be replaced with the pin coupler 546 of the preceding embodiment. The present embodiment differs only in the addition of an extra stiffening spine 1050 to the plate 1042 in a position running longitudinally thereof to impart extra rigidity to the plate 1042 to resist any potential vertical deflection forces exerted on the tine brace 1040 during use of the baler. In the case of a metal plate 1042, the stiffening spine 1050 may be a narrow length of rectangular metal stock welded to the plate 1042, or the stiffening spine may be an integrally incorporated feature of a molded or cast plate.

Commonality shared among the various embodiments contemplated above includes simple installation of a set of tine braces onto the bending prone wind-guard tines 32A using basic affordable fasteners, or self-retaining fastener-free attachment, in either case with no welding or other permanent affixation that cannot be reversed without destructive or detrimental effect to the wind-guard or the tine braces. This way a set of tine braces can be selectively installed for instances of use where the type or character of the hay or other material being collected denote a significant risk of bent hold-down tines, yet can be easily removed in non-destructive fashion to return the wind-guard to a conventional design, for example for use in instances where the type or character of the hay or other material being collected is one where the occupation of the spaces between the hold-down tines by the braces is potentially problematic to the proper operation of the baler or other collection machine, to a degree that outweighs the need for reinforced bracing of the wind-guard tines.

For example, relatively dry, finely cut hay may be less prone to bend the hold-down tines 32A, but owing to its lighter weight and smaller size, may tend be more prone to be blown upward and collect atop the plates of the installed braces, where build up of such hay could provide problematic to upper component of the baler that resides above the pickup assembly. Accordingly, a user may prefer to install the tine braces in preparation for collection and baling longer and/or wetter hay that prone to bending of the tines, but remove the tine braces in preparation for collection and baling of shorter and/or dryer hay where tine bending is less likely, and hay accumulation atop the tines braces may pose the greater potential detriment to the machine.

Where fasteners are used, they are used only to achieve attachment to the support bar 30, and not the hold-down tines 32A, 32B themselves. The tine blockers reside in deflection-blocking, close adjacency to the tines, optionally in partially embracing or fully surrounding circumferential relation thereto, yet in an unaffixed relation to the tine that retains the original structural integrity of the tine with zero modification thereto. In some embodiments, the tine blocker design takes advantage of the fact that some wind-guard support bars have pre-existing holes therein between the hold-down tines, thus enabling fastened connection to the support bar with zero modification thereto, while others make use of clamped connections to the support bar to likewise allow installation with zero modification to the wind-guard.

Since various modifications can be made in my invention as herein above described, and many apparently widely different embodiments of same made, it is intended that all matter contained in the accompanying specification shall be interpreted as illustrative only and not in a limiting sense.

1. In a ground-traversing collection machine comprising a pickup reel that spans laterally transverse of a forward travel direction of said machine to pick up material from a ground surface traversed thereby, a wind-guard residing overhead of said pickup reel and composed of a support bar lying laterally transverse of said forward travel direction and a plurality of hold-down tines projecting from said support bar in a longitudinally rearward direction of opposing relation to said forward travel direction to hold down the material as it is fed rearwardly from the pickup reel, and a set of stub augers positioned adjacent opposing ends of the pickup reel and operable to convey the material laterally inward toward a midplane of the machine from laterally outer regions thereof as said material is fed rearwardly from the pickup reel, an improvement to said wind-guard comprises a set of one or more tine braces installed or installable on the wind-guard in positions reinforcing one or more of said hold-down tines against potential deflection thereof by the material during laterally inward conveyance thereof by said set of stub augers.

2. The machine of claim 1 wherein each tine brace is positioned to brace against both the support bar, and at least one of the hold-down tines.

3. The machine of claim 1 wherein each tine brace comprises a plate residing in parallel relation to a common plane shared by two neighbouring hold-down tines between which said plate resides.

4. The machine of claim 3 wherein said plate resides coplanar to said two neighbouring hold-down tines in said common plane shared thereby.

5. The machine of claim 3 wherein said plate has a longitudinal edge running alongside a respective one of the hold-down tines, and an oblique edge of obliquely oriented relation to said longitudinal edge, and a tapered width of said plate between the longitudinal edge and the oblique edge grows wider toward the support bar.

6. The machine of claim 3 wherein said plate has a longitudinal edge along which the tine brace is equipped with a tine blocker for residing in adjacency to a respective one of hold-down tines to block deflection thereof.

7. The machine of claim 6 wherein each tine brace comprises, a location across the plate from the tine blocker, a second tine blocker for residing in adjacency to a neighbouring one of hold-down tines to also block deflection thereof.

8. The machine of claim 5 wherein said plate has a lateral edge residing in transversely oriented relation to said longitudinal edge, and in adjacency to the support bar.

9. The machine of claim 8 wherein said lateral edge resides in abutted adjacency to the support bar.

10. The machine of claim 3 comprising one or more coupling elements attached to, or defined in, said plate at location therein adjacent the support bar, by which the plate is coupled or couplable to the support bar.

11. The machine of claim 10 wherein said one or more coupling elements comprises one or more openings in the plate by which the plate is clamped or clampable to the support bar.

12. The machine of claim 1 each tine brace comprises a tine blocker of adjacent but unaffixed relation to a respective one of the hold-down tines to block deflection thereof.

13. The machine of claim 12 wherein said tine blocker curves at least partially around a circumference of said respective one of the hold-down tines.

14. The machine of claim 13 wherein said tine blocker is tubular so as to close fully around the circumference of said respective one of the hold-down tines.

15. The machine of claim 13 wherein said tine blocker is U-shaped to embrace partially around the circumference of said respective one of the hold-down tines.

16. The machine of claim 1 wherein each tine brace comprises at least one coupling component of outwardly projective relation to a remainder of the tine brace for penetrative receipt of said coupling component by a respective hole in the support bar.

17. The machine of claim 16 wherein said coupling component is a threaded stud engageable with a threaded nut to fasten the tine brace to the support bar.

18. The machine of claim 16 wherein said coupling component has a through-bore therein for receipt of a respective lock pin to fasten the tine brace to the support bar.

19. A tine brace for installation on a ground-traversing collection machine comprising a pickup reel that spans laterally transverse of a forward travel direction of said machine to pick up material from a ground surface traversed thereby, a wind-guard residing overhead of said pickup reel and composed of a support bar lying laterally transverse of said forward travel direction and a plurality of hold-down tines projecting from said support bar in a longitudinally rearward direction of opposing relation to said forward travel direction to hold down the material as it is fed rearwardly from the pickup reel, and a set of stub augers positioned adjacent opposing ends of the pickup reel and operable to convey the material laterally inward toward a midplane of the machine from laterally outer regions thereof as said material is fed rearwardly from the pickup reel, said tine brace comprising:
an elongated tine blocker running a longitudinal direction of the tine place for placement in adjacency to a respective one of the hold-down sides over at least a partial length thereof to block deflection of said respective one of the hold-down tines; and
one or more coupling elements of affixed relationship to said elongated tine block, and arranged for removably coupled attachment to the support bar to hold said elongated tine blocker in said adjacency to said respective one of the hold-down tines.

20. A method of adapting a ground-traversing collection machine for use in collecting a particular type of material using a pickup reel of said ground-traversing collection machine that is accompanied by a wind-guard having a plurality of hold down-tines, said method comprising selectively installing or removing a set of one or more tine braces on at least a subset of said hold-down tines according to whether said particular type of material is, or is not, one whose proper collection and handling by the machine would be negatively impacted by presence of said one or more tine braces on said hold-down tines of the wind-guard, to a degree exceeding beneficial reinforcement of the hold-down tines against deflective loading.
